(19) United States
(12) Patent Application Publication
(10) Pub. No.: US 2022/0198404 A1
(43) Pub. Date: Jun. 23, 2022

(54) ASSET HEALTH SCORE BASED ON DIGITAL TWIN RESOURCES

(71) Applicant: International Business Machines Corporation, Armonk, NY (US)

(72) Inventors: Lisa Seacat DeLuca, Bozeman, MT (US); Jonathan Tristan O'Gorman, Whitegate (IE)

(21) Appl. No.: 17/132,129

(22) Filed: Dec. 23, 2020

(51) Int. Cl. G06Q 10/00; G06Q 20/12; G06N 5/04

(52) U.S. Cl. CPC G06Q 10/20; G06N 5/04; G06Q 20/1235

(57) ABSTRACT

An approach to assigning health scores to physical assets based on digital twin resources. The approach can retrieve a digital twin with characteristics similar to a physical asset. The approach can predict a health score of the physical asset based on a first asset health formula associated with the digital twin.

### TECHNICAL FIELD

The present invention relates generally to determining an asset health score, and more specifically, to determining an asset health score based on asset digital twin resources.

### BACKGROUND

Resources such as International Business Machine's (IBM) “Digital Twin Exchange” allows manufacturers and original equipment manufacturers (OEM) to provide digital resources to owners and operators of the assets they provide. These digital resources help companies more intelligently operate their business. An important factor in this intelligent operation is understanding the health of the assets employed as part of the operation.

For example, IBM's “Maximo” application suite provides capabilities enabling organizations to understand the health of their assets. However, a critical piece associated with trusting the results is missing, there is a need to understand factors affecting the health of their assets and be able to derive an appropriate formula to calculate scores reflective of their health. Typically, it is a reliability engineer who is responsible for understanding the score, but other roles may also perform this task such as asset managers, etc. The formulas required to generate health scores can be complex and difficult to express. In addition, these users might not be aware of digital resources that exist to assist them in understanding the scores. What is needed is a way to add a level of trust to asset health scores through digital twin evidence.

### BRIEF SUMMARY

According to an embodiment of the present invention, a computer-implemented method for assigning health scores to physical assets based on digital twin resources, the computer-implemented method comprising: retrieving, by one or more processors, a digital twin with characteristics similar to a physical asset; and predicting, by the one or more processors, a health score of the physical asset based on a first asset health formula associated with the digital twin.

According to an embodiment of the present invention, a computer program product for assigning health scores to physical assets based on digital twin resources, the computer program product comprising: one or more non-transitory computer readable storage media and program instructions stored on the one or more non-transitory computer readable storage media, the program instructions comprising: program instructions to retrieve a digital twin with characteristics similar to a physical asset; and program instructions to predict a health score of the physical asset based on a first asset health formula associated with the digital twin.

According to an embodiment of the present invention, a computer system for assigning health scores to physical assets based on digital twin resources, the computer system comprising: one or more computer processors; one or more computer readable storage media; and program instructions stored on the one or more computer readable storage media for execution by at least one of the one or more processors, the program instructions comprising: program instructions to retrieve a digital twin with characteristics similar to a physical asset; and program instructions to predict a health score of the physical asset based on a first asset health formula associated with the digital twin.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

FIGS. 7A and 7B are examples of Health Score information for an asset, according to an embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of formulating an asset's health score based on digital twin resources. It should be noted that the term software, as used herein, includes any type of computer instructions such as, but not limited to, firmware, microcode, etc.

In a general embodiment of the present invention, a computer-implemented method can retrieve a digital twin with characteristics similar to a physical asset and can predict a health score of the physical asset based on a first asset health formula associated with the digital twin.

In another general embodiment, a system includes a processor and logic integrated with the processor, executable by the processor, or integrated with and executable by the processor. The logic is configured to perform the foregoing computer-implemented method.

In another general embodiment, a computer program product for install-time software validation includes a computer-readable storage medium having program instructions embodied therewith. The program instructions are executable by a computer to cause the computer to perform the foregoing computer-implemented method.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

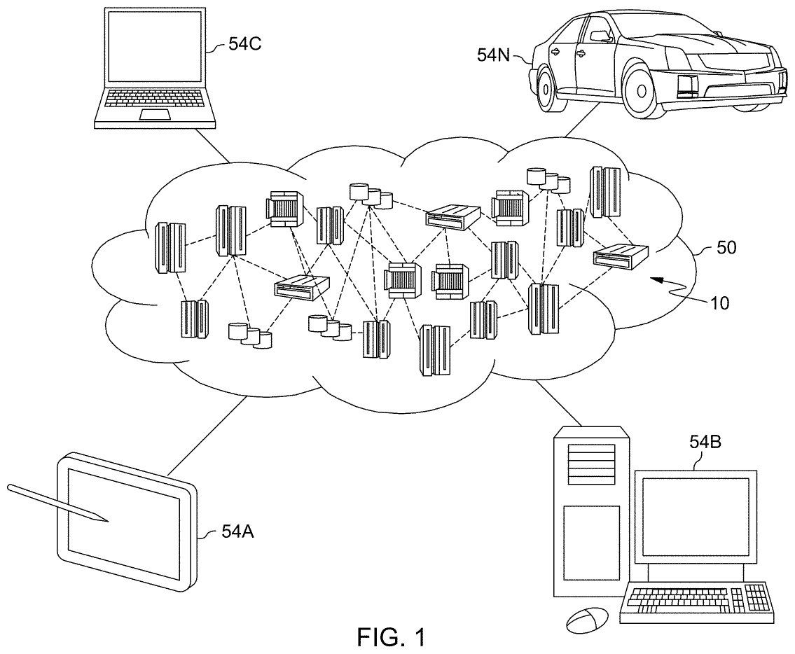

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

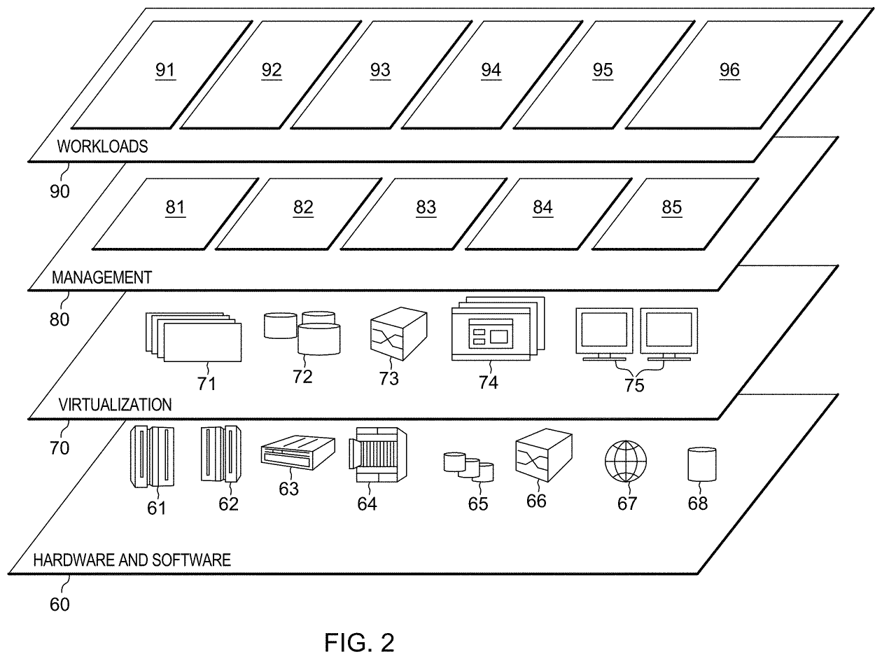

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and asset health formula generation based on digital twin resource relevance 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

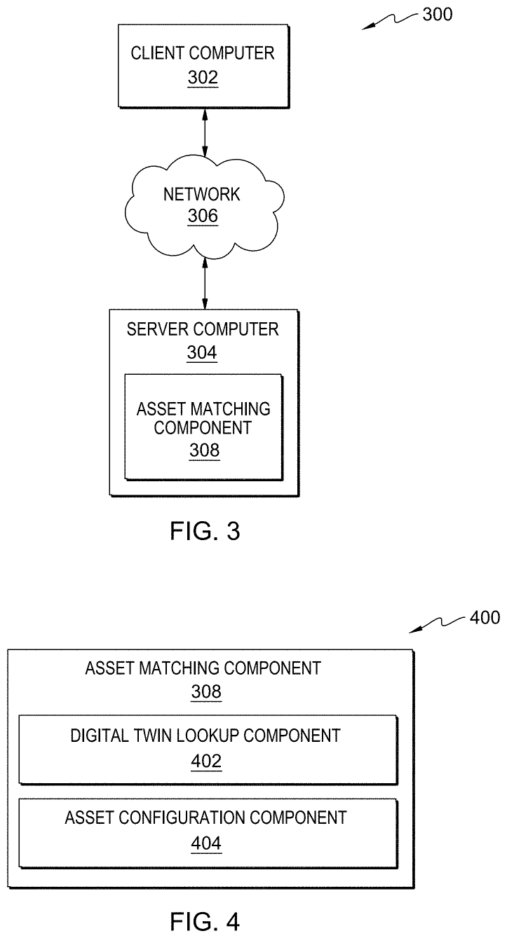

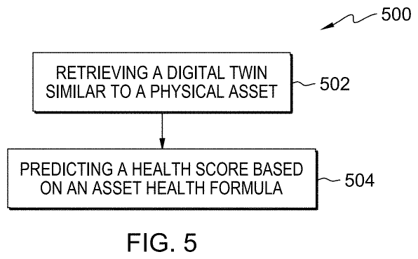

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram showing an exemplary processing system for predicting inference time for a machine learning model environment to which the invention principles may be applied. The architecture 300 comprises a client computer 302, an asset matching component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within user persona generation environment via network 306.

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 5.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within install-time validation environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

Asset matching component 308, operational on server computer 304, provides embodiments that can allow evidence from digital twin resource relevance to be used to generate a health formula for a group of associated assets. It should be noted that in this context, assets can include, but are not limited to, manufacturing equipment, laboratory equipment, office equipment, etc.

Asset matching component 308 can provide evidence based decisioning capability to manage the health of assets using internet of things (IoT) data from sensors associated with the assets and other resources such as, but not limited to, weather information, asset records, and work history. It should be noted that with the use of the aforementioned information, asset matching component 308 can present a consolidated global view of groups of assets. Based on this visibility, asset matching component 308 can increase asset availability and improve replacement planning by providing greater accuracy in decisions predicting asset maintenance and asset failure.

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, more or less elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise an asset matching component 308, further comprising a digital twin lookup component 402 and an asset configuration component 404.

The digital twin lookup component 402 can create an asset group that is related to a physical asset. The asset group can be visible to one or more of reliability engineers, asset managers, asset owners and individuals that are part of an organization that owns the physical asset. It should be noted that the asset group can be stored for later use in a user-defined preemptive maintenance schedule. Further, it should be noted that both the digital twin look-ups and the asset group information can be retrieved and/or stored on either user-owned repositories or commercially available repositories.

Digital twin lookup component 402 can apply an asset health formula to the asset group if the owner/operator of the asset group does not have an existing health formula and does not have the knowledge or skill to create an asset health formula. Digital twin lookup component 402 can do a lookup for available asset health formulas within a content store that matches the asset group within a predefined threshold. It should be noted that a content store can be a resource such as, but not limited to, International Business Machine Corporation's “Digital Twin Exchange.” Digital twin lookup component 402 can provide the identified asset health formula to asset configuration component 404.

Asset configuration component 404 can analyze the asset health formula provided by digital twin lookup component 402 to determine if the asset health formula is relevant. Asset configuration component 404 can then determine if the asset health formula is licensed for use in the present context.

If the asset health formula is licensed, then the asset configuration component 404 can display a link to copy the asset health formula of the physical asset of the current context and can provide evidence for why the digital twin asset health formula may be relevant to the current context. If the asset health formula is not licensed for use in the current context, asset configuration component 404 can provide a link to the digital twin asset health formula for a licensing request.

If the physical asset does not directly exist in the marketplace, but a similar physical asset exists (e.g., Acme pump is not available, but White Label pump is available) asset configuration component 404 can display a link to the digital twin health formula of the similar physical asset for a licensing request. Asset configuration component 404 can provide recommendations on how this digital twin asset health formula could be used and adapted for the current context.

Once asset configuration component 404 acquires a match for an existing asset health formula, asset configuration component 404 can train the health algorithm on the existing formula and perform a comparison of the current asset state to the established ground truth to determine the health of the physical asset given the baseline data. It should be note that asset configuration component 404 can continue to learn about the physical asset over time and can provide feedback to the content store regarding the asset health formula.

Considering an example of the embodiments disclosed herein, Marcia is a reliability engineer working for a water utility. Marcia's organization recently purchased IBM's Maximo Health (MH), implementing the embodiments disclosed herein. Marcia is responsible for configuring critical assets into MH and generating health scores of the physical assets.

Marcia begins by creating a group for the Acme centrifugal pumps that her organization maintains. Marcia navigates to the asset health formulation screen to begin creating the health scores. Marcia has never created an asset health formula for the health of these types of assets and does not know where to begin. Marcia clicks on the link for assistance via IBM's Digital Twin Exchange. Digital twin lookup component 402 compares the pumps she is working with to the available digital twins on IBM's Digital Twin Exchange. Digital twin lookup component 402 does not find an exact match, but a fuzzy search returns WhiteLabel centrifugal pumps.

Asset configuration component 404 recommends that the asset health formula for these pumps is likely to be similar to an asset health formula for the Acme pumps and can be adapted with minor modifications. Marcia is thrilled because this asset health formula can help her get quickly configure MH and she will have some intuition as to what modifications might be required. Asset configuration component 404 allows Marcia to license the digital twin resource from the IBM's Digital Twin Exchange and imports the licensed asset health formula into her MH instance. Marcia can then compare her asset based on the licensed asset health formula and determine a health score of 68, i.e., a fair reading. The analysis indicates the physical asset is likely going to fail in 120 days based on similar assets that have failed as predicted by the licensed formula. Further, this asset is likely to require maintenance in 90 days. The embodiments implemented herein allow IBM's MH application to learn from this digital twin asset and shorten the time for MH to learn the physical asset behavior, preventing an asset failure during operation. The benefit of the asset analysis based on digital twin asset health formulas is the information speeds up the time to value for Marcia and her team to get an accurate view of the health of their asset(s). In another aspect, if Marcia creates a novel formula for an asset, she can list it in IBM's Digital Twin Exchange for others to use.

FIG. 5 is an exemplary flowchart of a method 500 for assigning health scores to physical assets based on digital twin resources. At step 502, an embodiment can retrieve, via digital twin lookup component 402, a digital twin with characteristics similar to a physical asset. At step 504, the embodiment can predict, via asset configuration component 404, a health score of the physical asset based on a first asset health formula associated with the digital twin.

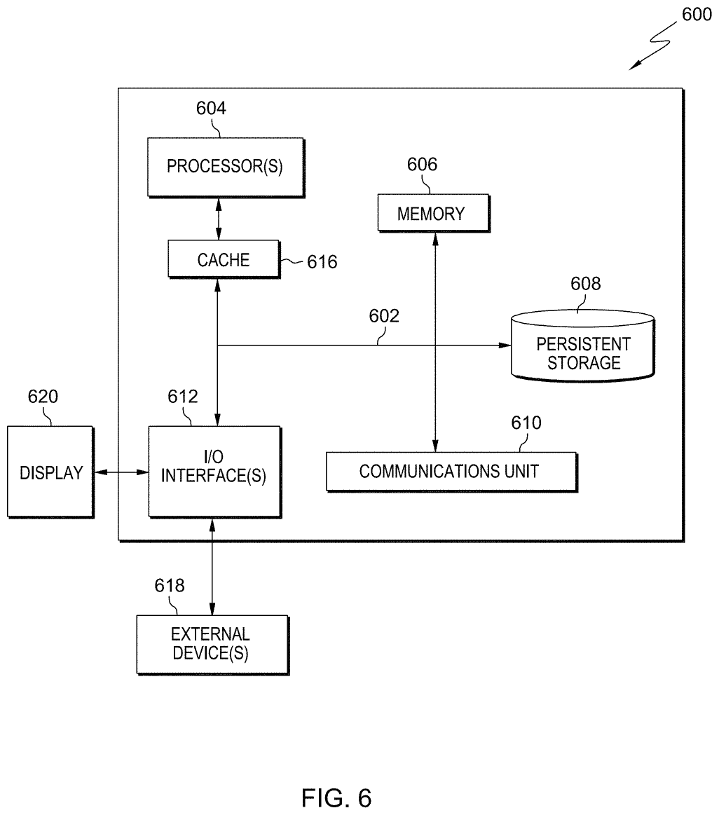

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

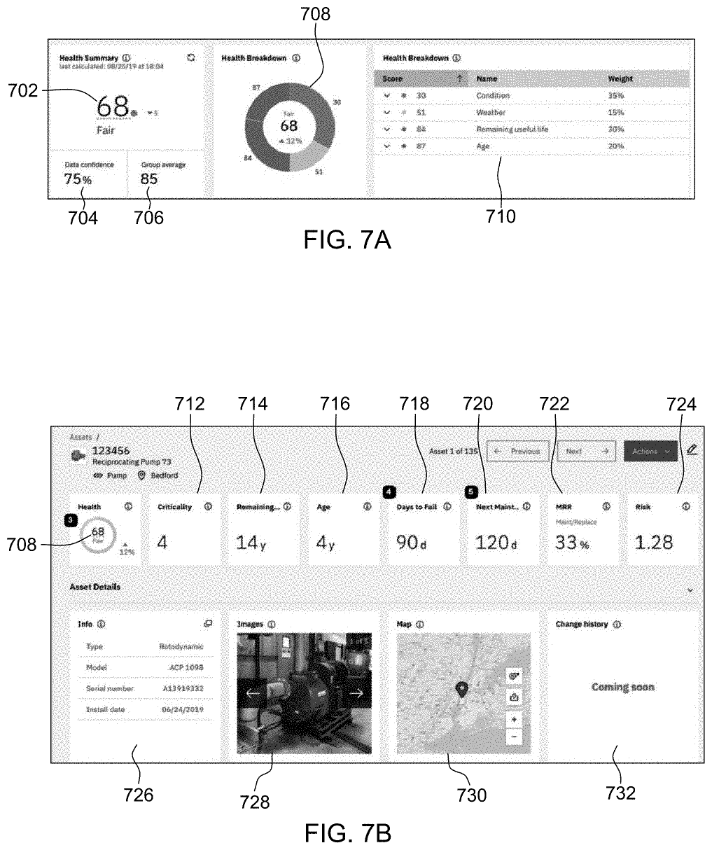

FIGS. 7A and 7B are examples of health scores for an asset. Looking to FIG. 7A, illustrated is a health summary score 702, including a data confidence score 704 and a group average score 706. Further, a health summary score is provided as a chart 708 and a table 710 displaying the components of the health breakdown. Turning now to FIG. 7B, is a detailed display of the health of a particular asset. The detailed display includes the overall health score chart 708 described above, a criticality rating 712 of the asset, a remaining life estimation 714 of the asset, an age 716 of the asset, a days to failure 718 prediction foe the asset, a time to next scheduled maintenance 720 schedule, a maintenance to replacement ratio 722 expressed as a percentage, a risk 724 prediction, information 726 specific to the item, an image 728 of the item, a map 730 showing the location of the item and a change history 732 for the item.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for assigning health scores to physical assets based on digital twin resources, the computer-implemented method comprising:
retrieving, by one or more processors, a digital twin with characteristics similar to a physical asset; and
predicting, by the one or more processors, a health score of the physical asset based on a first asset health formula associated with the digital twin.

2. The computer-implemented method of claim 1, further comprising:
creating, by the one or more processors, an asset group for grouping physical assets that are similar;
assigning, by the one or more processors, the physical asset to the asset group; and
storing, by the one or more processors, the asset group to use on a user-defined preemptive maintenance schedule.

3. The computer-implemented method of claim 2, further comprising:
deriving, by the one or more processors, a second asset health formula associated with the physical asset based on the first asset health formula and differences between the physical asset and the digital twin; and
storing, by the one or more processors, the second asset health formula in the asset group.

4. The computer-implemented method of claim 1, wherein the retrieving is from a user-owned repository.

5. The computer-implemented method of claim 1, wherein the retrieving is from a commercial repository wherein a user purchases a license.

6. The computer-implemented method of claim 1, further comprising:
providing, by the one or more processors, recommendations for changes to the first asset health formula to more closely match the physical asset.

7. The computer-implemented method of claim 2, wherein the storing is to a user-owned repository.

8. A computer program product for assigning health scores to physical assets based on digital twin resources, the computer program product comprising:
one or more non-transitory computer readable storage media and program instructions stored on the one or more non-transitory computer readable storage media, the program instructions comprising:
program instructions to retrieve a digital twin with characteristics similar to a physical asset; and
program instructions to predict a health score of the physical asset based on a first asset health formula associated with the digital twin.

9. The computer program product of claim 8, further comprising:
program instructions to create an asset group for grouping physical assets that are similar;
program instructions to assign the physical asset to the asset group; and
program instructions to store the asset group to use on a user-defined preemptive maintenance schedule.

10. The computer program product of claim 9, further comprising:
program instructions to derive a second asset health formula associated with the physical asset based on the first asset health formula and differences between the physical asset and the digital twin; and
program instructions to store the second asset health formula in the asset group.

11. The computer program product of claim 8, wherein the retrieving is from a user-owned repository.

12. The computer program product of claim 8, wherein the retrieving is from a commercial repository wherein a user purchases a license.

13. The computer program product of claim 8, further comprising:
program instructions to provide recommendations for changes to the first asset health formula to more closely match the physical asset.

14. The computer program product of claim 9, wherein the storing is to a user-owned repository.

15. A computer system for assigning health scores to physical assets based on digital twin resources, the computer system comprising:
one or more computer processors;
one or more computer readable storage media; and
program instructions stored on the one or more computer readable storage media for execution by at least one of the one or more processors, the program instructions comprising:
program instructions to retrieve a digital twin with characteristics similar to a physical asset; and
program instructions to predict a health score of the physical asset based on a first asset health formula associated with the digital twin.

16. The computer system of claim 15, further comprising:
program instructions to create an asset group for grouping physical assets that are similar;
program instructions to assign the physical asset to the asset group; and
program instructions to store the asset group to use on a user-defined preemptive maintenance schedule.

17. The computer system of claim 16, further comprising:
program instructions to derive a second asset health formula associated with the physical asset based on the first asset health formula and differences between the physical asset and the digital twin; and
program instructions to store the second asset health formula in the asset group.

18. The computer system of claim 15, wherein the retrieving is from a user-owned repository or a commercial repository wherein a user purchases a license.

19. The computer system of claim 15, further comprising:
program instructions to provide recommendations for changes to the first asset health formula to more closely match the physical asset.

20. The computer system of claim 16, wherein the storing is to a user-owned repository.
